(19) United States
(12) Patent Application Publication
(10) Pub. No.: US 2007/0162321 A1
(43) Pub. Date: Jul. 12, 2007

(54) Outsourcing of services

(75) Inventors: Bryan L. Behrmann, Fenton, MO (US); Michael D. Dunagan, Poughkeepsie, NY (US); Eric Pyle, Wappingers Falls, NY (US); Thomas Ward, Highland, NY (US); Terell White, Cairo, NY (US)

Correspondence Address: FLEIT, KAIN, GIBBONS, GUTMAN,;BONGINI & BIANCO P.L., 551 NW 77TH STREET, SUITE 111, BOCA RATON, FL, 33487, US

(73) Assignee: INTERNATIONAL BUSINESS MACHINES CORPORATION, ARMONK, NY (US)

(21) Appl. No.: 11/324,958

(22) Filed: Jan. 3, 2006

(51) Int. Cl. G06F 15/02

(52) U.S. Cl. 705/9

(57) ABSTRACT

A method for identifying human-resource work content to outsource offshore of an organization. The method is provided on a computer readable medium and includes the steps of identifying at least one task being performed by an organization; associating each identified task with a functional group within a plurality of functional groups related to the organization; determining information about individual human resources spent on each task; determining task information about human resources spent on the plurality of tasks, the task information based on the determined information about individual human resources spent on each task; using the determined task information to determine a value of each task; and outsourcing tasks having a value lower than a predefined limit to at least one of offshore and to a low cost supplier.

### BACKGROUND OF THE INVENTION

1. Field of the Invention

The present invention relates generally to outsourcing services and more particularly, to a system, method, and storage medium for objectively identifying, analyzing, selecting, documenting, consolidating, and migrating intermediate procurement sourcing knowledge and tasks.

2. Background of the Invention

The world has become a global economy. As a result, more and more domestic based companies are taking advantage of cheaper resources, such as labor and materials, available in other countries. In recent years, corporations have looked increasingly to outsourcing of services, development, and manufacturing work as a strategy to reduce labor, administration, development, and manufacturing expense. If used for the correct services and products and properly executed, outsourcing can make a business more efficient by reducing the overall end-to-end costs. On the other hand, if used for services that are excessively complex or that are executed improperly, outsourcing can result in increased overall end-to-end costs.

Although the concept may seem straight forward, in practice, making the correct decision on which services to outsource, and which to continue to keep in house (at a domestic facility), is difficult. At the highest level, to make the correct decision, all that needs to be done is to determine which services are at the basic end of the scale and which are at the complex end.

Basic services would be in a group consisting of those tasks that are easy to carry out. The basic services group would be those services that typically represent low-end services, or those that require less-skill and lower-cost labor. Low end services would be among the first service candidates to outsource since they are generally easier to teach and carry out.

A second group of services, the “complex” services, consist of more high-end services that may require specialized skills, more experienced workers, education, and a specialized training. High-end services would most often remain in house and in the hands of experienced employees that have already developed these specialized skills.

A third group of services fall in between the low-end and high-end services. Mid-range services are more difficult to fit into categories due to the fact that they can potentially be outsourced, but may not be available for outsourcing due to a multitude of factors.

In practice, determining which services are basic, which are complex, and which are in between is a difficult endeavor. The determination cannot be made by only considering which are high-end services and which are low-end services. Most, or at least many, jobs entail specific tasks that range from low-end to high-end.

Determining which services are too complex and difficult to outsource and which are not, continues to be a challenge. In order to be successfully migrated to an outsourcing location, the tasks need to be able to be documented, repeatable, and able to be migrated at low risk to the corporation. Risk can be defined in terms of customer satisfaction, continuity of business, cost savings, business controls, and legal exposure to the corporation. No known solutions exist that both identify the universe of tasks performed and then select those tasks that are able to be consolidated and migrated.

With current outsourcing determination methods, outsourcing a job may be declined because one or more of a single worker's tasks are too complex. Prior-art methods and systems for making outsourcing determinations have suffered from the disadvantage of being based on high-level subjective opinions and on a viewing a worker's job as a single service entity. Incorrect decisions have been shown to have less than optimal consequences.

Accordingly, a need exists to overcome the difficulties with optimizing services outsourcing and to provide an objective and more repeatable system to determine services outsourcing decisions.

### SUMMARY OF THE INVENTION

The present invention provides a system and method for identifying at least a portion of a human-resource within an organization for outsourcing. In an embodiment of the present inventions, the method includes receiving a list of a plurality of tasks being performed by a plurality of individual human resources within a given portion of an organization and grouping each of the tasks into a plurality of functional groups so that each of the functional groups represent an end result for the plurality of tasks associated therewith. The method also includes receiving an amount of the individual human resources spent on each of the tasks within the functional groups and aggregating the amount of the individual human resource spent on each of the tasks to provide a total aggregate time for each of the tasks within the functional groups across the organization. In an additional step, tasks are identified based upon the total aggregate time for outsourcing to a lower cost supplier.

In one embodiment, the amount of individual human resources spent on each task includes a percentage of a total amount of an individual human resource spent on each task.

In an embodiment of the present invention, the amount of individual human resources spent on each task is a number between zero and one hundred percent.

In embodiments of the present invention, the task is selected from a group consisting of procurement tasks, human resource management tasks, customer relationship tasks, and financial tasks.

In another embodiment of the present invention, the outsourcing to a lower cost supplier includes maintaining at least one performance parameter throughout and following at least a transition period.

In an embodiment of the present invention, the method further includes developing a project plan for migrating the tasks which have been identified for outsourcing before outsourcing the tasks.

The invention also includes an information processing system for identifying at least a portion of a human-resource within an organization for outsourcing. The system includes a processing circuit coupled to an input/output driver. The input/output driver receives a list of a plurality of tasks being performed by a plurality of individual human resources within a given portion of an organization and an amount of the individual human resources spent on each of the tasks within a functional group of a plurality of functional groups. The processing circuit performs the functions of grouping each of the tasks into the plurality of functional groups so that each of the functional groups represent an end result for the plurality of tasks associated therewith; aggregating the amount of the individual human resource spent on each of the tasks to provide a total aggregate time for each of the tasks within the functional groups across the organization; and identifying tasks based upon the total aggregate time for outsourcing to a lower cost supplier.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a flow diagram illustrating a method of identifying and outsourcing services, according to the present invention

FIG. 2 is a flow diagram illustrating a method for identifying tasks for outsourcing, according to the present invention.

FIG. 3 is flow chart of building Table 3 from Table 1 and Table 2, according to the present invention.

FIG. 4 is a flow diagram illustrating a method of developing a migration project plan, according to the present invention.

FIG. 5 is a flow diagram illustrating a method for implementing a task migration plan, according to the present invention.

FIG. 6 is a flow diagram illustrating a method of migrating tasks to an outsourcing location, according to the present invention.

FIG. 7 is a block diagram illustrating the general components of a computer, according to the present invention.

### DETAILED DESCRIPTION

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

While the specification concludes with claims defining the features of the invention that are regarded as novel, it is believed that the invention will be better understood from a consideration of the following description in conjunction with the drawing figures, in which like reference numerals are carried forward.

Overview

“Outsourced” services are services that are performed by those other than employees within the subject company utilizing the present invention. Outsourcing is often performed in countries where cheaper labor prices and/or cheaper materials are available. Outsourcing can also include domestic services performed by others at a lower cost to the subject company. “In-house” services are services performed by or directly under the direction of the subject company itself. In-house services are generally reserved for services that have a high degree of complexity or other various attributes that will be discussed below. One of the advantages of the present invention is that various service types are readily recognized, broken down into individual tasks, and are analyzed in detail for a determination of sourcing designation.

Described now is an exemplary method and system for assigning scientific complexity quantification values to individual services for accurate and objective sourcing determinations. The present invention produces a specific task migration plan, which is tracked and evaluated for savings and efficiency. After the migration plan is created, specific jobs are organized into specific tasks, which are categorized into functional groups. A determination is then made for each task as to allocation of time by individuals and also the entire organization. Based on the determination, a migration project plan is developed and implemented to outsource candidate tasks. A post-migration monitoring system is then implemented to capture an accurate metric of savings and efficiencies realized. The post-migration results are then used, if necessary, to alter the task migration plan. The result is a substantial transition of workload to low-cost countries in a short transition period while maintaining business performance and client satisfaction.

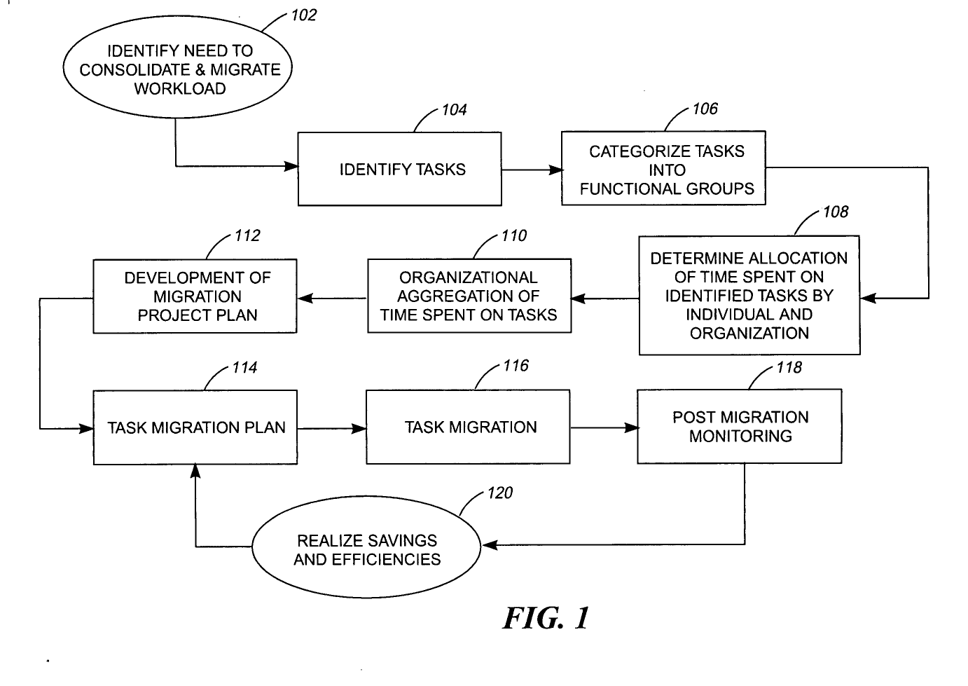

The steps of the present invention are shown in FIG. 1 and described in detail below. FIG. 1 is a process chart illustrating an end-to-end knowledge transfer process in accordance with an embodiment of the present invention. Although the present invention can be used for migration of any type of service such as financial tasks, human resource management tasks, logistics tasks, training tasks, transition tasks, and infrastructure tasks to an outsourced location, the remainder of this disclosure will describe and give examples of services that pertain to procurement functions within a subject company.

Referring now to FIG. 1, the process of the present invention begins at step 102 where a need to consolidate and migrate a workload is contemplated. The flow then moves to step 104 where individual tasks within an organization are identified.

Task Identification

In step 104, a comprehensive list of intermediate sourcing tasks being performed by an organization is created. The list creation involves an end-to-end review of the current workflows within each department. For example, the function of supplier selection is comprised of smaller tasks which include: pricing, contracting, business controls, client and supplier management, sales support, interlocks with accounting, and operational reporting requirements, among others.

Table 1 shows an exemplary list of tasks associated with a procurement function within a company.

TABLE 1
Bid Phase/Transition Phase/Service Delivery
Business Controls & Compliance Testing
Client Education/Account Review
Client Strategy/Relationship
Contract, management of deliverables e.g. statement of work (SOW),
amendments
Directly Generating Revenue by Providing Procurement Services to
External Customers
Invoicing Issues/Accounts Payable Interface
Low-Complexity Requisition Processing
Operational Reports
Supplier Qualification, Selection, Evaluation, and Optimization
Supplier/Commodity Strategy

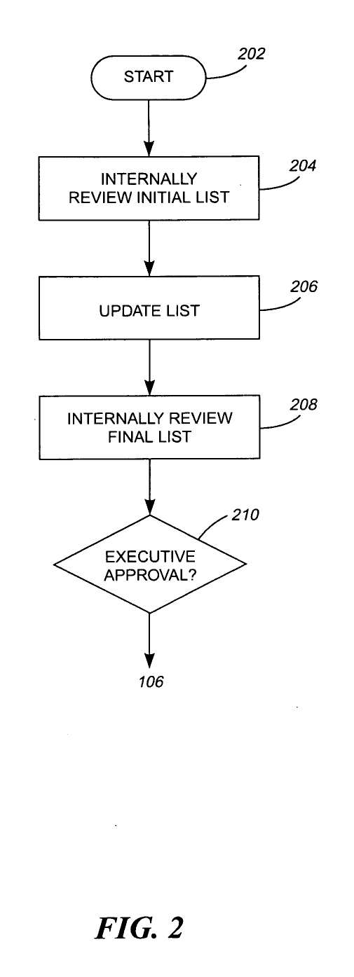

In one embodiment of the present invention, once the initial intermediate sourcing tasks list is generated, sub-steps within step 104 are followed, which are shown in FIG. 2. The process flow begins at step 202 and moves directly to step 204 where the list is internally reviewed with, for example, team leaders and management, to ensure the list is comprehensive and there is consistency in the definition of tasks. The list is then updated in step 206. In a further sub-step, step 208, the final list is reviewed with, for example, executive management for approval. If the list receives executive approval, in step 210, the flow moves to the next step 106 of the overall process, shown in FIG. 1, where the tasks are categorized. If the list does not receive executive approval, the flow moves back up to step 206, where the list is updated and then again submitted for executive approval in step 208.

Task Categorization

The next step is to categorize the intermediate sourcing tasks into functional groups. Functional groups are defined as those tasks which share a relation to the end results of the task. Each functional group describes the types of skills necessary to perform the tasks within the group and is made of those intermediate procurement sourcing tasks that meet the criteria of being able to be documented, repeated, and migrated at low risk to the corporation. In one embodiment of the present invention, risk is defined in terms of customer satisfaction, continuity of business, cost savings, business controls, and legal exposure to the corporation.

Exemplary functional groups according to one embodiment of the present invention are:
1. Commercial Procurement—Includes those tasks associated with directly generating revenue by providing procurement services to external customers.
2. Client Relationship—Includes those tasks associated with the development and support of the client strategies and relationships. Those tasks include bid phase/transition phase/service delivery support and client education/account reviews.
3. Strategic Sourcing—Includes those tasks associated with the development and deployment of a supplier and commodity strategy. Those tasks include supplier qualification, selection, evaluation, supplier optimization, and contracting—which includes the drafting of master agreements, statements of work (SOW), amendments and the management of those documents.
4. Operations & Transactions—Includes those tasks associated with the development, generation, and distribution of operational reports and the processing of purchase orders in compliance with existing sourcing strategies. Those tasks include any invoicing issues and accounts payable interface, maintenance of a strong business controls compliance posture by adherence to existing strategies and periodic testing of those processes, and the processing of low complexity/low risk purchase requisitions into purchase orders. Risk is defined in terms of customer satisfaction, continuity of business, cost savings, business controls, and legal exposure to the corporation.

Once the tasks are placed into their appropriate categories, the flow moves to step 108, where an allocation of the amount of time each employee spends on each task is performed.

Allocation of Time Spent Performing Tasks

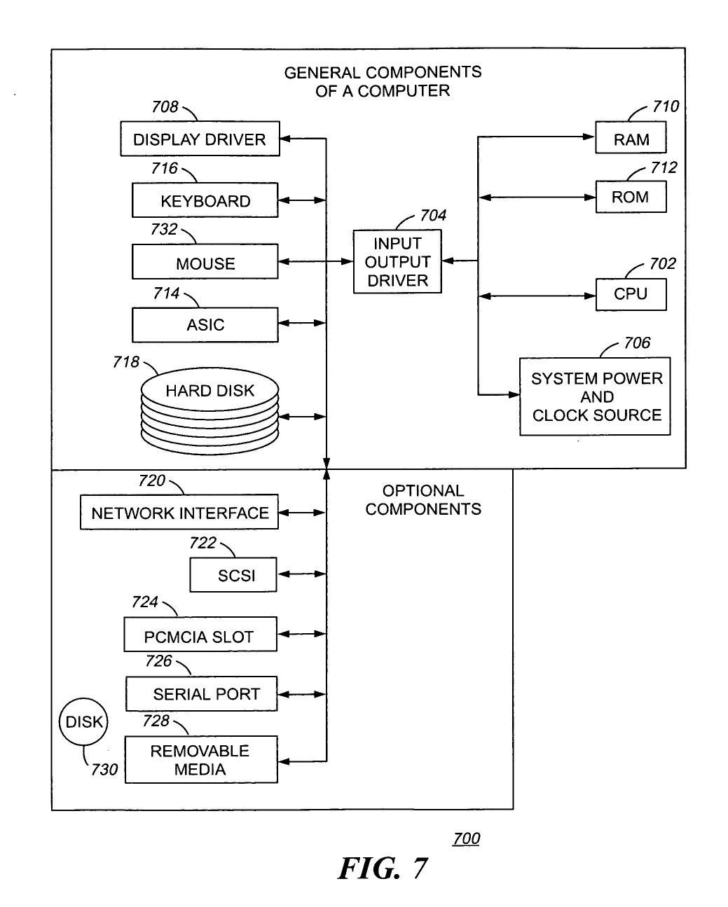

Allocation of time spent performing tasks is the next step in the process of the present invention. The percentage of time each employee spends performing tasks within a group is calculated using a computer as described in FIG. 7 below. Table 2 shows an exemplary time allocation for five employees.

TABLE 2

| | Commercial | Client | | Operations/ | | |
|---|---|---|---|---|---|---|
| Resource | Procurement | Relationship | Sourcing | Transactions | Total | Notes |
| Employee 1 | 0% | 10% | 75% | 15% | 100% | Client/Non Core |
| | | | | | | Interaction/SOW-Contract/Client |
| | | | | | | Education |
| Employee 2 | 0% | 10% | 75% | 15% | 100% | Outsourcing Engagements, Client |
| | | | | | | Interactions, SOW - updates |
| Employee 3 | 0% | 10% | 75% | 15% | 100% | Client/Non Core Interaction/ |
| | | | | | | SOW - Contract Work |
| Employee 4 | 0% | 15% | 75% | 10% | 100% | Client/Non Core Interaction/ |
| | | | | | | SOW-Contract Work/Cost |
| | | | | | | Savings |
| Employee 5 | 0% | 20% | 70% | 10% | 100% | Sourcing/Council Projects/ |
| | | | | | | Cost Savings/Other |
| Total-Pct. | 0% | 13% | 74% | 13% | 100% | |
| Total- | 0 | .65 | 3.7 | .65 | 5 | |
| FTE | | | | | | |

Table 2 illustrates a single employee divides his or her time amongst a variety of tasks throughout a single workday or workweek. In only rare instances does a job entail performing only a single task. For example, Employee 1, as shown in Table 2, spends approximately 10% of his/her time on Client Relationship tasks, 75% on Sourcing tasks, and 15% on Operational/Transactional level tasks. Advantageously, if one or more tasks can be taken from an employee and outsourced to a lower-cost location, the employee will be able to allocate a larger percentage of his/her time to performing the more complicated tasks and will, therefore, become more productive to the company.

When the assessment is completed for each employee—the times are aggregated together to determine the total percentage of time across the department and the resulting full-time equivalent (FTE) allocated to each task grouping. This assessment should include a weighted average for full time, part time and contract employees.

Based on the individual task allocations in step 108, the information is aggregated to create an organizational total of task workload in step 110.

Organizational Aggregation of Time Spent

In the next step 110, an organizational aggregation of the full-time equivalents, grouped by task, is completed across all departments in the organization. This aggregation is performed advantageously by a computer as described in FIG. 7 below. This aggregation is advantageous feature of the present invention because often, when looking to outsource the responsibilities of an organization, companies only look at individual roles and responsibilities and try to determine if an entire job can be moved or not. When this aggregation is completed across an entire organization, one can assess the full scope of work which is transferable at a top level. Therefore, with the summation of full-time equivalent resources by job grouping across all departments, the top-down organizational total of task workload becomes available.

Table 3 shows the number of full-time equivalents (FTEs) each department requires per functional group. Calculating the number of FTEs advantageously allows a plan to be created that shifts outsourceable tasks from workers so that their tasks can be outsourced and not the worker himself.

TABLE 3

| Full-Time | | | | | | Organiza- |
|---|---|---|---|---|---|---|
| Equivalents | Dept. 1 | Dept. 2 | Dept. 3 | Dept. 4 | Dept. 5 | tion |
| Commercial | — | — | 4.00 | 8.00 | — | 12.00 |
| Procurement | | | | | | |
| Client | 3.40 | 4.80 | 5.65 | 2.00 | 1.55 | 17.40 |
| Relationship | | | | | | |
| Sourcing | 4.40 | 5.65 | 4.50 | 5.50 | 9.65 | 29.70 |
| Operations/ | 5.20 | 4.55 | 7.85 | 1.50 | 4.80 | 23.90 |
| Transactions | | | | | | |
| Total | 13.00 | 15.00 | 22.00 | 17.00 | 16.00 | 83.00 |

For example, as reflected in Table 3, focusing on the Operations and Transactions functional group as a source of work content to outsource to a low cost site, a head count of approximately 24, or 30% of the total workload, is identified for transfer. Because this amount of work content is a percentage of each individual's tasks, the work responsibilities of the sending organization will to be restructured and rebalanced upon the transfer of this work.

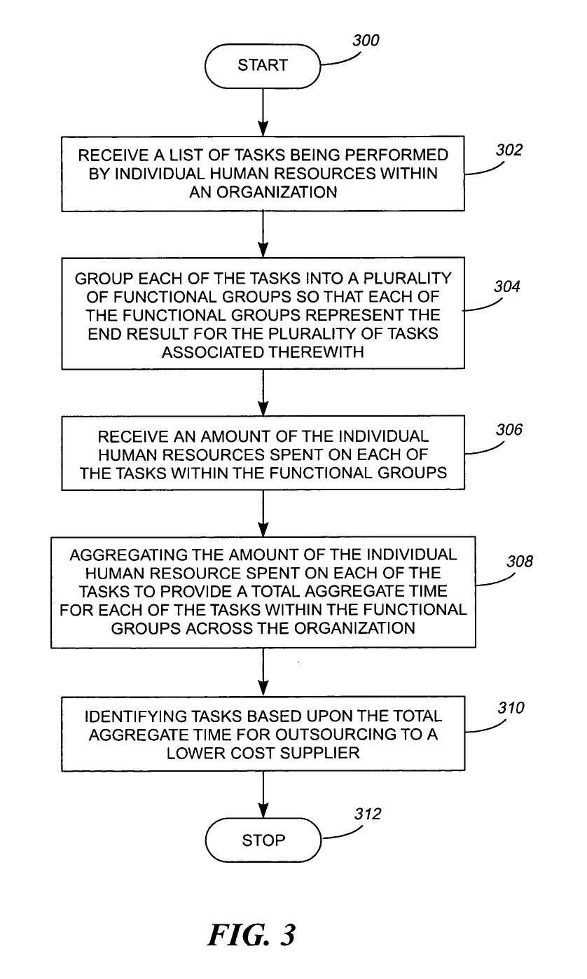

FIG. 3 is flow chart showing the present invention thus far described. The flow begins at step 300 and moves directly to step 302 where a list of tasks being performed by individual human resources within an organization is received. An exemplary list is shown in Table 1. The list can be in any format that can be read by a computer program product. Next, in step 304 each of the tasks is grouped into a plurality of functional groups, such as the exemplary function groups listed above. Each of the functional groups represents the end result for the plurality of tasks associated therewith. In step 306, an amount of the individual human resources spent on each of the tasks within the functional groups is received. As also described above, Table 2 is an exemplary breakdown of human resources spent on a plurality of tasks with each of a plurality of exemplary functional groups. The next step, 308, is to aggregate the amount of the individual human resource spent on each of the tasks. The aggregation provides a total aggregate time for each of the tasks within the functional groups across the organization. An exemplary aggregation is shown in Table 3. Then, in step 310, tasks are identified for outsourcing to a lower-cost supplier. The tasks are based upon the total aggregate time. The process stops at step 312.

Returning to the overall process flow chart shown in FIG. 1, the next step is the project management of the migration of tasks.

Development of Migration Project Plan

As shown in FIG. 1, the flow moves from step 110 to step 112, where the project plans to achieve this are set forth. In step 112, based on the information gathered in the previous steps, a detailed project plan is developed to ensure the appropriate resources, funding, approvals, and risk mitigation steps are addressed. This involves outlining the entire process involved, and breaking these tasks into workstreams.

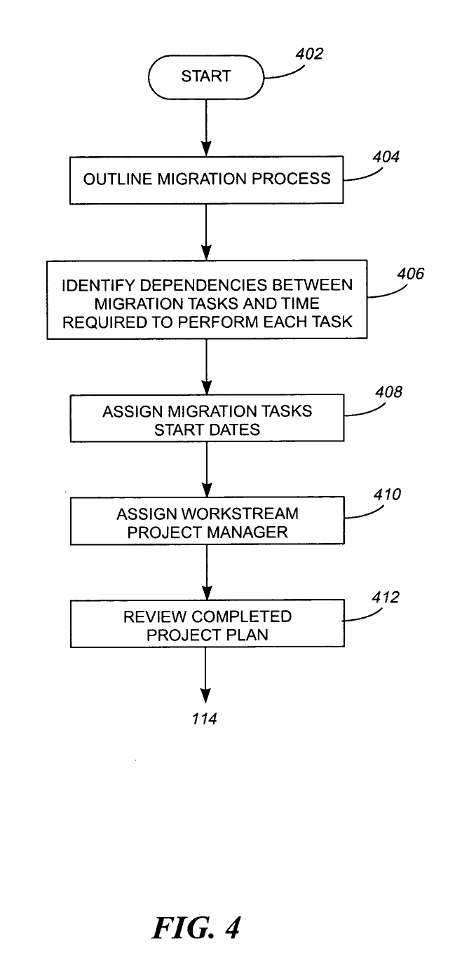

Referring now to FIG. 4, a process flow chart illustrating sub-steps within step 112 is shown. The flow begins at step 402 and moves directly to step 404, where the entire migration process is outlined. The migration process includes identifying the migration tasks and breaking these tasks into major workstreams. A few exemplary workstreams are:
Financial—tasks associated with the executive management approval of appropriation of the investment, including necessary resource hiring approvals, travel, infrastructure improvements, facilities, and miscellaneous expenses associated with the project.
Human Resource—tasks associated with resource hiring, including advertisement, recruiting, interviewing, offer and acceptance, orientation, and training.
Logistics—tasks associated with any necessary travel requirements, including the reservations of air travel, hotels, ground transportation, local training facilities, meals, visas and passports.
Training—tasks associated with the training of resources, including those tasks associated with identifying and selecting the training material necessary, preparing the training material, reviews with management and subject matter experts, selecting and training of trainers, and closed loop quality assessments.
Transition—tasks associated with the migration of work tasks, including the identification of key performance indicators (KPI), periodic transition review meetings with key stakeholders and management, on-going tracking of progress against the KPI targets, and action plans to address identified gaps. Examples of a KPI are average cycle time to process a purchase order and an average annual cost savings per employee.
Infrastructure—tasks associated with installation of necessary infrastructure improvements, including telephony, IT equipment solution, connectivity, network service, and storage medium.

After the migration tasks have been allocated to the workstreams, the next step 406 is to identify dependencies between migration tasks and time required to perform each task. Based on these time requirements and dependencies, migration tasks are then assigned, in step 408, migration start dates in an order that minimizes total transition time. This assignment of tasks creates the project baseline. Once the baseline is complete, the process moves to step 410, where workstream project managers are assigned to ensure the completion of tasks. Then, in step 412, the completed project plan is reviewed for final approval. The process then moves on to step 114 of FIG. 1.

Table 4 shows a portion of an exemplary completed project plan.

TABLE 4

| ID | Task Name | Duration | | Start | Finish | Predecessors | Resource Names |
|---|---|---|---|---|---|---|---|
| 1 | ISS Migration to IOC-Phase 2 | 85 | days? | Feb. 7, 2005 | Jun. 3, 2005 | | |
| 2 | Finance | 17 | days | Feb. 7, 2005 | Mar. 1, 2005 | | T. Ward |
| 3 | ISC Review Board Approvals | 5 | days | Feb. 7, 2005 | Feb. 11, 2005 | | |
| 4 | Prepare ISC Forms | 1 | day | Feb. 7, 2005 | Feb. 6, 2005 | | T. Ward |
| 4 | Pre-submit Approval | 1 | day | Feb. 8, 2005 | Feb. 8, 2005 | 4 | T. Ward |
| 5 | Executive Sponsor Approval | 1 | day | Feb. 9, 2005 | Feb. 9, 2005 | 5 | K. Fuller, |
| | | | | | | | I. Crawford |
| 6 | HR Review | 3 | days | Feb. 9, 2005 | Feb. 11, 2005 | | P. Barton |
| 7 | Finance Review (Tues Only) | 1 | day | Feb. 9, 2005 | Feb. 9, 2005 | | M. Lipner |
| 8 | CPO Approval | 3 | days | Feb. 9, 2005 | Feb. 11, 2005 | | J. Paterson |
| 9 | ISC Review Board (Fri only) | 1 | day | Feb. 11, 2005 | Feb. 11, 2005 | | P. Barton |
| 10 | ICAs | 12 | days | Feb. 14, 2005 | Mar. 1, 2005 | 10 | T. Ward, |
| | | | | | | | P. Sandhu |
| 11 | ICA Drafting-Complete through | 10 | days | Feb. 14, 2005 | Feb. 25, 2005 | | Tom W., |
| | 2Q2005 | | | | | | P. Sandhu |
| 12 | Finalize ICA | 1 | day | Feb. 28, 2005 | Feb. 28, 2005 | 12 | |
| 13 | ICA Signing | 2 | days | Feb. 28, 2005 | Mar. 1, 2005 | | T. Ward, P. Sandhu |
| 14 | Misc. Funding | 10 | days | Feb. 14, 2005 | Feb. 25, 2005 | | |
| 15 | Meeting Card-yes | 1 | day | Feb. 14, 2005 | Feb. 14, 2005 | | |
| 16 | Approval for Travel Dollars | 1 | day | Feb. 15, 2005 | Feb. 25, 2005 | 16 | Tom Ward |
| 17 | Create PO | 7 | days | Feb. 17, 2005 | Feb. 25, 2005 | 17 | |

The next step 114 is the creation of a task migration plan.

Task Migration Plan

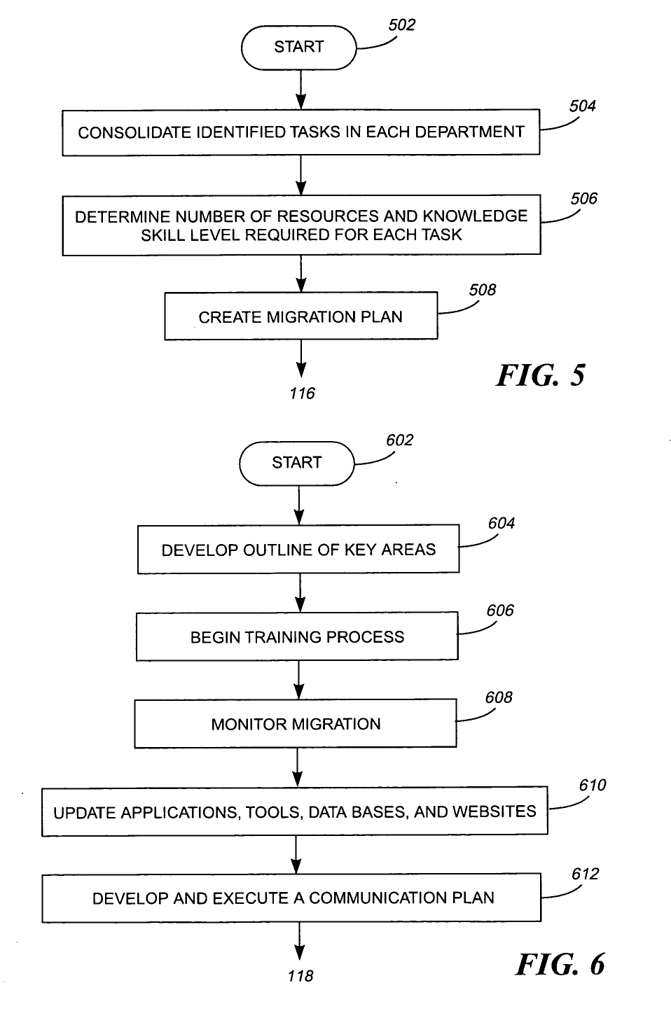

This component is made up of several sub-steps, which are shown in the process flow diagram of FIG. 5. The flow begins at step 502 and moves directly to step 504, where the various tasks within each department that have been identified for migration through the previous components are consolidated. Next, in step 506, a determination is made as to the number of resources and knowledge skill level required for each task to be migrated. Then, in step 508, a plan is created whereby these tasks and knowledge skills will be migrated, with a focus on mitigating risks to the organization. The flow them moves on to step 116, shown in FIG. 1. Upon completion of step 114, there should be a clear illustration of the migration plan, similar to that set forth in Table 5.

TABLE 5

| Department | Task | HC | Phase 1 | Phase 2 | Phase 3 |
|---|---|---|---|---|---|
| Dept. #1 | Core Supplier, to $150K | 2 | 2 | — | — |
| | Core Supplier, to $250K | 1 | — | 1 | — |
| | Core Supplier, to $500K | 1 | — | 1 | — |
| Dept. #2 | All Suppliers, up to $50K | 1 | — | 1 | — |
| | All Suppliers, up to $100K | 2 | — | 1 | 1 |
| | All Suppliers, up to $500K | 2 | — | — | 2 |
| Dept. #3 | Core = any, Non-Core < $100K | 1.5 | 1 | .5 | |
| Dept. #4 | Core = any, Non-Core < $100K | 1 | 1 | .5 | |
| Dept. #5 | Managerial role for HC | 1 | 1 | — | — |
| | Total | 13 | 5 | 5 | 4 |

As Table 5 shows, the migration is scheduled to occur in stages, with each department having an individual transition plan. The head count (HC) needed for each task is identified, along with the phases that the work is to be migrated.

The next step 116 is the migration of the tasks to the new entity. This step consists of multiple sub-steps, each of which is important to a successful migration and shown in FIG. 6.

The process shown in FIG. 6 begins at step 602 and moves directly to step 604 where a document outlining the areas that are key to successful employee training is developed. This document should be utilized by the project team throughout the training process and project closeout to ensure that an effective knowledge transfer occurs for each trainee and validate that the knowledge is received and understood by each trainee.

Upon completion of the training outline and modules, the training process moves to step 606, where the training process begins. This training process can be provided via numerous methods with the end result being that the new resources have satisfactorily met all of the education criteria set forth in the training outline and the trainee(s) have a clear understanding of the tasks that they will be performing to ensure a seamless transition.

In step 608 the migration is monitored. A key to successful training is the continuous monitoring of the training progress and feedback from the trainees. This continuous monitoring allows for ongoing enhancement of the education process to ensure the successful completion of all education criteria and objectives.

An exemplary chart showing training progress is illustrated in Table 6.

TABLE 6

| | | Dept. #1 | | Dept. #2 | | Dept. #3 | | |
|---|---|---|---|---|---|---|---|---|
| | | Empl. | Empl. | Empl. | Empl. | Empl. | Empl. | |
| Training Progress Chart | | #1 | #2 | #3 | #4 | #5 | #6 | Overall |
| Week 1 | Understanding the | Good | Good | Good | Good | Good | Good | Good |
| | Overall Process | | | | | | | |
| | Knowledge Transfer | Good | Good | Good | Good | Good | Good | Good |
| | from Trainer | | | | | | | |
| | Trainee absorbing the | Good | Good | Good | Good | Good | Good | Good |
| | knowledge transfer | | | | | | | |
| | Process specific/ | Avg. | Avg. | Avg. | Low | Avg. | Avg. | Avg. |
| | exceptions | | | | | | | |
| | Hands on Experience | Good | Good | Good | Good | Good | Good | Good |
| | Supplier Interaction | Good | Good | Good | Good | Good | Good | Good |
| | Client/Network | Good | Good | Good | Good | Good | Good | Good |
| | Interaction | | | | | | | |
| | Documentation | Good | Good | Good | Good | Good | Good | Good |
| | Overall | Good | Good | Good | Avg. | Good | Good | Good |

In Table 6, each employee's training progress is documented for each training area. The employee's ratings can be averaged over all of the training areas to give an overall training score that can be used to evaluate the training program, the employee, and the migration process.

Upon successful completion of the training for the newly boarded resources, the transition of the previously identified roles and responsibilities will begin. As part of this, all applications, tools, databases, and web sites are updated, in step 610, to reflect the new owner. The final step, 612, is the development and execution of a communication plan to all the key stakeholders to whom the

| | | | | | | | |
|---|---|---|---|---|---|---|---|
| Overall | Good | Good | Good | Good | Good | Good | Good |

moves out to step 118 in FIG. 1 for post-migration monitoring.

Post Migration Monitoring

This step consists of the monitoring of the workload transitioned for a set period of time to insure seamless transition. Upon completion of this step, the migration is complete and resources are available for additional revenue generating tasks. Table 7 shows an exemplary post-training progress chart.

TABLE 7

| | | Dept. #1 | | Dept. #2 | | Dept. #3 | | |
|---|---|---|---|---|---|---|---|---|
| Post Training Progress Chart | | Empl. #1 | Empl. #2 | Empl. #3 | Empl. #4 | Empl. #5 | Empl. #6 | Overall |
| Week 1 | Trainer/Trainee | Good | Good | Good | Good | Good | Good | Good |
| | weekly checkpoint | | | | | | | |
| | meeting | | | | | | | |
| | Supplier Interaction | Good | Good | Good | Good | Good | Good | Good |
| | Client/Network | Good | Good | Good | Good | Good | Good | Good |
| | Interaction | | | | | | | |
| | Process specifics/ | None | None | None | None | None | None | Good |
| | exceptions | | | | | | | |
| | Weekly PO Audit | Good | Good | Good | Good | Good | Good | Good |
| | Results | | | | | | | |
| | IT Issues | Good | Good | Good | Good | Good | Good | Good |
| | Escalations | None | None | None | None | None | None | Good |
| | Number of reqtrackers | 0 | 0 | 0 | 0 | 0 | 0 | Good |
| | created (below | | | | | | | |
| | transfer levels) | | | | | | | |
| | IOC Number of | 9 | 5 | 17 | 5 | 5 | 15 | Good |
| | Requests Processed | | | | | | | |
| | IOC Turn Around | 3.33 days | 4.66 days | .66 days | .88 days | 1 day | 1 day | Good |
| | Time | | | | | | | |
| | Overall | Good | Good | Good | Good | Good | Good | Good |

Savings and Efficiencies

It is a goal of the present invention to generate savings to the subject company. As the process leaves step 118, an evaluation is performed in step 120 to realize savings and efficiencies within the subject company that are attributable to the present invention. The results of this evaluation are then fed back to step 114, where they can be interpreted and integrated in the task migration plan to adjust the plan as needed. This check and adjustment can be performed continuously, periodically, or at event driven times.

Information Processing Unit

The present invention can be realized in whole or in part on an information processing system and the processes shown in the flow diagrams herein can be carried out by executing instructions contained in a computer-readable medium and read by the information processing system. Referring to FIG. 7, there is shown a block diagram 700 of the major electronic components of an information processing system 700 in accordance with the invention. The electronic components include: a central processing unit (CPU) 702, an Input/Output (I/O) Controller 704, a mouse 732, a keyboard 716, a system power and clock source 706, display driver 708, RAM 710, ROM 712, ASIC (application specific integrated circuit) 714, and a hard disk drive 718. These are representative components of a computer.

The general operation of a computer comprising these elements is well understood. Network interface 720 provides connection to a computer network such as Ethernet over TCP/IP or other popular protocol network interfaces. Optional components for interfacing to external peripherals include: a Small Computer Systems Interface (SCSI) port 722 for attaching peripherals, a PCMCIA slot 724, and serial port 726. An optional diskette drive 728 is shown for loading or saving code to removable diskettes 730. The system 700 may be implemented by combination of hardware and software. Moreover, the functionality required for quantifying outsourcing metrics may be embodied in computer-readable media (such as a compact disk (CD) 730) to be used in programming an information-processing apparatus (e.g., a personal computer) to perform in accordance with the invention. It should be noted that an information processing unit is not necessary for realizing the present invention.

Conclusion

The terms “a” or “an,” as used herein, are defined as “one or more than one.” The term “plurality,” as used herein, is defined as “two or more than two.” The term “another,” as used herein, is defined as “at least a second or more.” The terms “including” and/or “having,” as used herein, are defined as “comprising” (i.e., open language). The terms “program,” “software application,” and the like as used herein, are defined as “a sequence of instructions designed for execution on a computer system.” A program, computer program, or software application typically includes a subroutine, a function, a procedure, an object method, an object implementation, an executable application, an applet, a servlet, a source code, an object code, a shared library/dynamic load library and/or other sequence of instructions designed for execution on a computer system.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A computer program product for identifying at least a portion of a human-resource within an organization for outsourcing, the computer program product comprising:
a storage medium readable by a processing circuit and storing instructions for execution by the processing circuit for performing a method comprising:
receiving a list of a plurality of tasks being performed by a plurality of individual human resources within a given portion of an organization;
grouping each of the tasks into a plurality of functional groups so that each of the functional groups represent an end result for the plurality of tasks associated therewith;
receiving an amount of the individual human resources spent on each of the tasks within the functional groups;
aggregating the amount of the individual human resource spent on each of the tasks to provide a total aggregate time for each of the tasks within the functional groups across the organization; and
identifying tasks based upon the total aggregate time for outsourcing to a lower cost supplier.

2. The computer program product according to claim 1, wherein the receiving the amount of individual human resources spent on each task includes a percentage of a total amount of an individual human resource spent on each task.

3. The computer program product according to claim 2, wherein the receiving the amount of individual human resources spent on each task is a number between zero and one hundred percent.

4. The computer program product according to claim 1, wherein the task is selected from the group consisting of procurement tasks, human resource management tasks, customer relationship tasks, and financial tasks.

5. The computer program product according to claim 1, wherein the outsourcing to a lower cost supplier includes maintaining at least one performance parameter throughout and following at least a transition period.

6. The computer program product according to claim 1, further comprising:
developing a project plan for migrating the tasks which have been identified for outsourcing before outsourcing the tasks.

7. The computer program product according to claim 6, wherein the step of developing a project plan comprises:
identifying migration tasks; and
dividing the migration tasks into workstreams.

8. The computer program product according to claim 7, wherein the workstreams include at least one of financial, human resources, logistics, training, transition, and infrastructure.

9. The computer program product according to claim 7, wherein the step of developing a project plan further comprises:
assigning a migration start date to each task, whereby each start date is assigned in an order that minimizes a total transition time of migrating all tasks to outsourcing.

10. The computer program product according to claim 1, wherein the functional groups include at least one of commercial procurement, client relationship, strategic sourcing, and operations and transactions.

11. A computer program product for identifying human-resource work content to outsource offshore of an organization, the computer program product comprising:
a storage medium readable by a processing circuit and storing instructions for execution by the processing circuit for performing a method comprising:
identifying a task being performed by an individual in an organization, the task being a portion of an individual's overall job within the organization;
determining other individuals in a department within the organization performing the task which has been identified;
determining an amount of time each individual in the department dedicates to the task which has been identified in a given period of time;
aggregating the amount of time each of the individuals in the department dedicate to the task; and
migrating to a location offshore from the organization, an amount of work substantially equal to the amount of time which has been aggregated.

12. The computer program product according to claim 11, further comprising:
determining an outsource value for each of the tasks before the step of migrating.

13. The computer program product according to claim 11, further comprising:
implementing at least one performance parameter for the task; and
maintaining the at least one performance parameter throughout and following at least a transition period after the migrating step.

14. The computer program product according to claim 11, further comprising:
placing the task into one of a plurality of functional groups, wherein the functional groups include commercial procurement, client relationship, strategic sourcing, and operations and transactions.

15. The computer program product according to claim 11, further comprising:
identifying migration tasks; and
dividing the migration tasks into workstreams.

16. The computer program product according to claim 15, wherein the workstreams include at least one of financial, human resources, logistics, training, transition, and infrastructure.

17. An information processing system for identifying at least a portion of a human-resource within an organization for outsourcing, the system comprising:
a processing circuit coupled to an input/output driver, wherein the input/output driver receives each of:
a list of a plurality of tasks being performed by a plurality of individual human resources within a given portion of an organization; and
an amount of the individual human resources spent on each of the tasks within a functional group of a plurality of functional groups,
at least a first algorithm executing on the processing circuit for grouping each of the tasks into the plurality of functional groups so that each of the functional groups represent an end result for the plurality of tasks associated therewith;
at least a second algorithm executing on the processing circuit for aggregating the amount of the individual human resource spent on each of the tasks to provide a total aggregate time for each of the tasks within the functional groups across the organization; and
at least a third algorithm executing on the processing circuit for identifying tasks based upon the total aggregate time for outsourcing to a lower cost supplier.

18. The information processing system according to claim 17, wherein the receiving the amount of individual human resources spent on each task includes a percentage of a total amount of an individual human resource spent on each task.

19. A method for identifying at least a portion of a human-resource within an organization for outsourcing, the method comprising:
receiving a list of a plurality of tasks being performed by a plurality of individual human resources within a given portion of an organization;
grouping each of the tasks into a plurality of functional groups so that each of the functional groups represent an end result for the plurality of tasks associated therewith;
receiving an amount of the individual human resources spent on each of the tasks within the functional groups;
aggregating the amount of the individual human resource spent on each of the tasks to provide a total aggregate time for each of the tasks within the functional groups across the organization; and
identifying tasks based upon the total aggregate time for outsourcing to a lower cost supplier.
